(19) United States
(12) Patent Application Publication
(10) Pub. No.: US 2022/0171698 A1
(43) Pub. Date: Jun. 2, 2022

(54) SCALABLE SIMULATION AND AUTOMATED TESTING OF MOBILE VIDEOGAMES

(71) Applicant: WARNER BROS. ENTERTAINMENT INC., Burbank, CA (US)

(72) Inventor: Alejandro S.S. Azapian, San Mateo, CA (US)

(21) Appl. No.: 17/602,725

(22) PCT Filed: Apr. 10, 2020
(86) PCT No.: PCT/US20/27838

§ 371 Date: Feb. 8, 2022

Related U.S. Application Data
(60) Provisional application No. 62/832,541, filed on Apr. 11, 2019.

(51) Int. Cl. G06F 11/36

(52) U.S. Cl. CPC G06F 11/3688; G06F 11/3696

(57) ABSTRACT

A method for evaluating performance of a video game by a computing device. The method includes a harness application independent of device's execution context, and an agent application to simulate player's actions.

### CROSS-REFERENCE TO RELATED APPLICATION

The present application is a 371 of International Application Serial No. PCT/US2020/027838, filed Apr. 10, 2020, which claims priority to U.S. provisional patent application Ser. No. 62/832,541, filed Apr. 11, 2019, which are incorporated herein by reference.

### FIELD

The present application relates to simulation and automated testing, and more particularly to systems and methods for simulating and automated testing of mobile video games using an automated agent.

### BACKGROUND

A recurring problem in the field of videogames and 3D software applications is how to automatically test a product to find defects. While traditional form-based apps can benefit from User Interface (UI) Automation, 3D applications and video games usually cannot benefit from this approach, as their built-from-scratch UI is incompatible with prior automation packages for testing software.

Consequently, Quality Assurance (QA) analysts must manually exercise all the code paths of a videogame, trying to identify oddness in the behavior and/or images produced by the product. The nature of Mobile Application development further exacerbates this problem, due to the myriad different device manufacturers, chipset vendors and operating system versions in the market. A game that operates without errors on one device may fail on a similar device.

While prior approaches to automating mobile video games have been implemented, these have fallen short of automating the function of a QA analyst. For example, prior approaches have lacked the ability to simulate a player analyst who exercises different software code paths in search of potential errors. Nor is this a trivial technical problem to solve. Code paths leading to errors are not easily discovered for several reasons, such as the complexity of gaming code paths, the difficulty of accurately simulating human player behavior with an automated agent, and problems with distinguishing errors from acceptable outcomes from a human player's perspective. Because of these and other challenges, automated testing of 3D apps and videogames has been an open problem without a clear solution.

It would be desirable, therefore, to provide new methods and other new technologies able to simulate and automate testing of mobile video games to identify software defects and that overcome these and other limitations of the prior art.

### SUMMARY

This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect of the disclosure, a method evaluates performance of a video game by a computing device. In an aspect, the computing device is a mobile device and the video game is a mobile video game. In an aspect, the method automates a QA agent in mobile video games. In another aspect of the disclosure, an apparatus or local server automates continuous execution of a QA agent in mobile video games. In an aspect, the method may include three main components: (a) an on-device agent application, (b) a harness application and (c) an execution context. Generally, the harness application enables an automatic starting of a video game (e.g., “bootstrapping”) and deploying of an agent application that plays the game automatically in an execution context (e.g., a specific mobile phone or operating system). In some embodiments, the execution context may be a local device. In some embodiments, the execution context may be one or more servers, for example, continuous integration (CI) servers (e.g., a remote “device farm”) which includes hundreds of readily-available devices for testing purposes. The deployment of the “custom made” harness application allows the same tests to be “portable” between different execution contexts.

In an aspect, the method includes executing, by a processor of the computing device, the harness application for the video game. The method may deploy the harness application in remote devices, which are referred to as the computing devices. This advantageous deployment allows for scalable and automated testing of video games in mobile devices.

The harness application extracts variable values from a memory of the computing device and sends data based on the values to a data sink. The variable values include, for example, one or more predefined objectives of a video game play, and descriptions of an execution context. Data sent to the data sink may include test outcomes from games that are tested based on the predefined objectives of a video game play in an execution context. The data sink may be, or may include, a computer memory for storage or temporary use by an application.

Other data collected by the harness application may also include, for example, screenshots, current framerate, measure of CPU usage, measure of graphics processor usage, measure of memory usage, measure of power drain, or a measure of screen brightness. In an aspect, the data may be analyzed, and the analysis will help in developing future agent application for testing the video game or other video games.

In some embodiments, a data sink may be a computer-readable data storage medium or another computing medium. The data sink may be coupled to the computing device by a serial port or a network interface. In some embodiments, the data sink is hosted by a local apparatus or server. In some embodiments, the data sink may be hosted by one or more remote servers (e.g., at a device farm). The remote server may also host a data management application that causes the server to receive the data from the computing device and record the data in the data sink. The data management application may further cause the server to receive additional data like the data from multiple different computing devices contemporaneously performing the method.

Contemporaneously with executing the harness application, the method includes executing, by a processor of the computing device, an agent application for the video game that executes player commands for the video game based on a script and state of the computing device determined by the video game. In an aspect, the agent application may be encoded in a script, and is configured to simulate likely actions that real players may perform in a video game. In another aspect, agent application is encoded as a part of the video game. The agent builds an internal representation of the current state of the game and determines which actions may be played for each game state.

Contemporaneously with executing the harness application and the agent application, the method includes executing, by a processor of the computing device, the video game that accepts input generated by the agent application as player input. As the agent plays the video game it detects errors. For example, if the agent tries to perform an action that a player is not allowed to perform from a given screen according to its data file, it detects an error if the game allows the action to be completed. Conversely, if the game does not allow an action that is indicated in its data file as allowable, the agent may register an error. In an aspect, the agent application may detect and report errors to an interface or record for QA analysis.

In an aspect, the method includes continuing executing the harness application, the agent application, and the video game until achieving a predefined objective of video game play, for example, reaching a destination or completing a campaign. In an aspect, the agent application causes the computing device to read a data file that defines one or more game objectives. The data file may be preloaded in the mobile device contemporaneously with the deploying of the harness application. In addition or alternatively, the computing device may read the data file from an external data source through a communication interface, for example a network interface. The agent application then causes the computing device to generate simulate game-related user input based on the one or more game objectives.

In an aspect, the agent application may cause the computing device to generate the simulated user input at least in part by reacting to a detected state of the video game according to at least one predefined algorithm.

In an aspect, the method includes continuing executing the harness application, the agent application, and the video game indefinitely. In some embodiments, the method performs this execution from an apparatus or local server that automates continuous execution of the agent application in mobile video games.

The methods described herein provide an automated process for automatically evaluating performance of a video game by a computing device. Applications for the methods may include, for example, automatically testing of a video game in a mobile device. The method may include, for example, enabling a QA analyst to script and deploy simultaneously, on hundreds of devices, the on-device agent application that plays the video game automatically. The agent application simulates a real-life player and gathers execution statistics. In an exemplary application, the method may simulate high-level game-specific tasks such as “Go to the Campaign Map”, “Build a Superteam” or “Go to Battle”, as well as gather metrics like recording battery drain over time, frames-per-second performance and capture in-game screenshots, among others.

The foregoing methods may be implemented in any suitable programmable computing apparatus, by provided program instructions in a non-transitory computer-readable medium that, when executed by a computer processor, cause the apparatus to perform the described operations. The computer processor (or “processor”) may be local to the apparatus and user, located remotely, or may include a combination of local and remote processors. An apparatus may include a computer or set of connected computers that is used in audio-video or production or for output of audio-video or virtual or augmented reality content to one or more users. Other elements of the apparatus may include, for example, a user input device, which participate in the execution of the method.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the examples may be employed. Other advantages and novel features will become apparent from the following detailed description when considered in conjunction with the drawings and the disclosed examples, which encompass all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify like elements correspondingly throughout the specification and drawings.

FIG. 1 is a schematic diagram illustrating an overview of evaluating performance of a video game by a computing device.

FIG. 2 illustrates an overview of connectivity between a harness application, an agent application and a video game when all three modules are loaded in a mobile device.

FIG. 3 is a block diagram illustrating an example of a computer network in which the novel methods and apparatus of the present disclosure may find use.

FIG. 4 is a diagram illustrating aspects of various test case data structures.

FIG. 5 is a flow diagram illustrating a high-level process of building and executing an automatic evaluation performance of a video game by a computing device.

FIG. 6 is an exemplary program script of an automatic evaluation performance of a video game by a computing device.

FIG. 7 shows an execution flow of the script in FIG. 6 in a single device.

FIG. 8 shows an execution flow of the script in FIG. 6 in a farm device.

FIG. 9 is a flow diagram illustrating an automatic process of an agent application.

FIG. 10 is a conceptual block diagram illustrating components of an apparatus or system for the methods of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form to facilitate describing these aspects and novel combinations of elements.

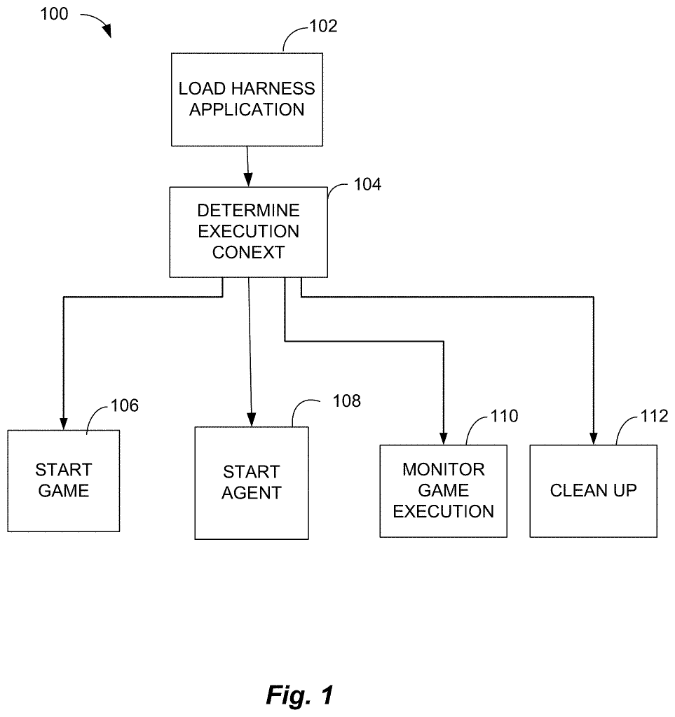

FIG. 1 illustrates an overview 100 of automatically evaluating performance of a video game by a computing device. A performance evaluation may also be referred to as testing. The method 100 may be performed by one or more computer processors, for example with some processes at a server while some processes at a mobile device. At the process 102, the one or more processors load a harness application to an execution context, which in the present disclosure means the execution environment. An execution context may be, for example, multi-platform device installations (sometimes called “farms”) for concurrent testing of software on multiple different models of mobile devices or models running different operating systems. An execution context may also be a single-device installation for testing. An execution context may be local or remote to a human QA administrator supervising the testing. The identification of an execution context may be received or selected from a local database or from a remote or distributed database. As such, in an aspect, the one or more processors load the harness application into a single mobile device for testing a video game in the mobile device. In another aspect, the one or more processors load one or more harness applications to a device farm, which in turn loads execution-context specific harness applications into multiple different models of mobile devices or models running different operating systems for testing of video game in each of the mobile device.

In an aspect, one or more processors may load the harness application inside the same process space as the rest of the video game. In some embodiments, security measures included in the one or more processors, in the mobile device and/or in the harness application may implement protection to prevent inadvertently unwanted software from being loaded with or in place of the harness application.

At computer process 104, the harness application determines the execution context it is operating in. In some embodiments, each mobile device has already contained the video game to be tested and an agent application. The on-device agent application tests the video game automatically by simulating actions of a real-life player and gathers execution statistics. The agent application may be programmed to receive and record high-level instructions from a user (e.g., QA engineer), and use an execution loop to perform the instructions. Using a lookup table or the like, the agent application distinguishes between successful execution of high-level instructions and errors. The agents compare clicks and other actions required to achieve a game result in a particular context to a standard for the context and flags any errors for human review.

At computer process 106, the harness application starts the execution of the video game. The video game then waits for input actions. In an aspect, at the computer process 108, the video game starts the execution of the on-device agent application which provides input actions to the video games to simulate a player's actions. The agent application monitors the testing, gathers statistics and screenshots if so directed. At computer process 110, the harness application waits for signal from the agent application. In an aspect where a single test run is configured, for example by the QA analyst or administrator, the agent application signals that testing of the video game has completed when, for example, all script instructions have been executed. At 112, once testing of the video game has completed, the harness application performs clean up tasks, for example storing test results, clearing and freeing memory and data usage. In an aspect where continuous test is configured, the agent application restarts from the first instruction.

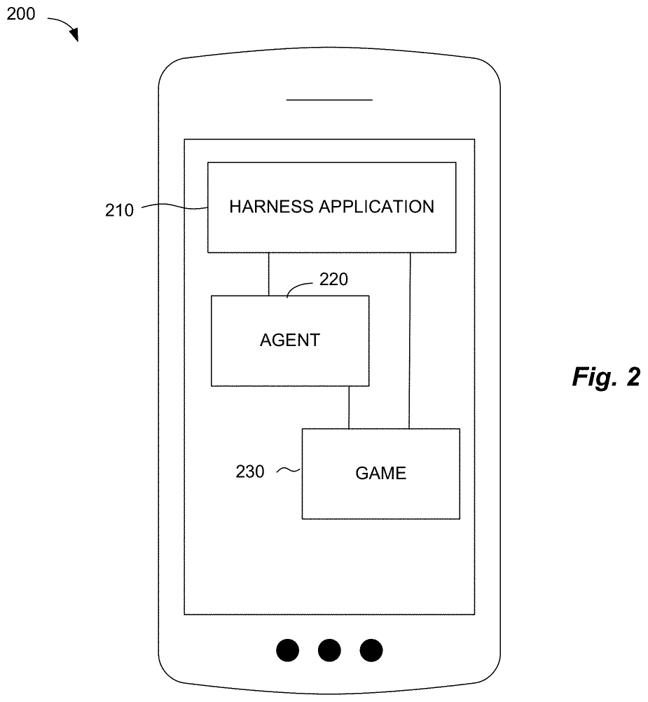

FIG. 2 illustrates a conceptual overview of connectivity between a harness application 210, an agent application 220 and a video game 230 when all three modules are loaded in the mobile device 200. The view of FIG. 2 is not meant to depict any output on display 250. Generally, the game 230 runs and produces most or all of output that appears on the display 250 without any indication of the agent 220 or harness application 210. Optionally, the display can show an indicator of the harness application 210 or agent 220 (e.g., an icon indicating the application is running. The block diagram on the screen 250 illustrates a three-way interface between the harness application 210, the agent 220, and game 230. Each application interfaces with both other applications. The harness 210 interfaces with the agent 220 and game 230, the agent 220 interfaces with the harness 210 and game 230, and the game 230 interfaces with the agent 220 and harness 210.

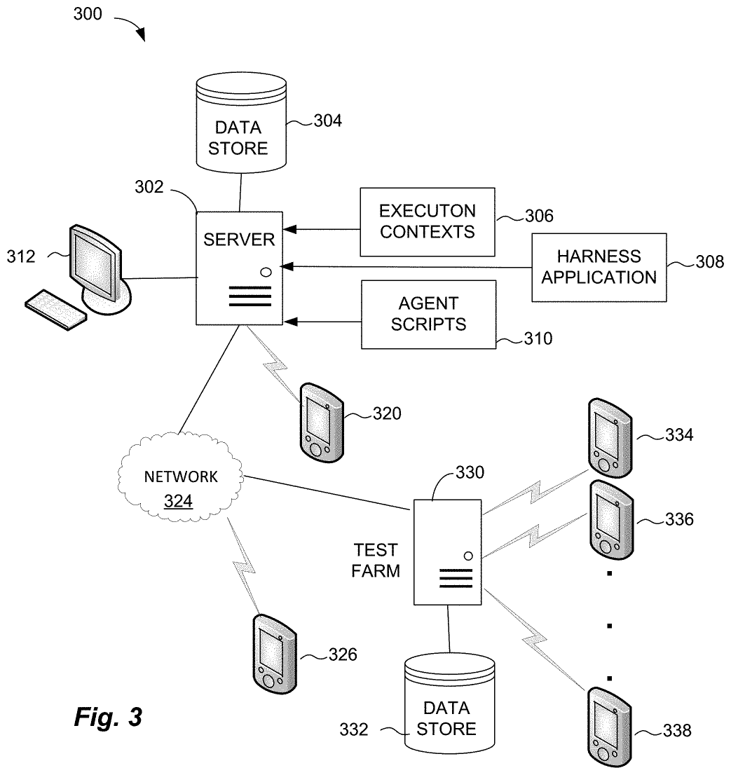

FIG. 3 shows an example of a computer network 300 in which the novel methods and system of the application may find use. In an aspect, one or more servers 302 (e.g., a local server) interconnected through a local wireless network, wide area network 324, or other network may execute the processes and algorithms described herein, automatically evaluating performance of a video game by local mobile device 320, or remote mobile device 326. In another aspect, one or more servers 330 (e.g., a device farm) may execute the processes and algorithms described herein, automatically evaluating performance of a video game by multiple mobile devices 334, 336, 338 connected to the device farm server 330. Mobile devices 334-338 may be different models running different operating systems.

One or more processors of the servers may enable automatic performance evaluation of a video game at one or more mobile devices with the execution of an on-device agent application that simulates actions of a player. In one aspect, the one or more processors determine, for example by retrieving from storage 304, the execution context 306 for each mobile device. Based on the execution context 306, the one or more processors load a corresponding harness application 308 to the mobile device. In an aspect, the one or more processors load an agent application script 310 built into a video game to the mobile device. The video game and the built-in agent application may be pre-loaded to the mobile device or may be loaded to the mobile device by the one or more processors contemporaneously to loading the harness application.

In an aspect, a monitor 310 is connected to the servers for displaying a live feed coming directly from the mobile device's screen. The monitor can also display full client and server logs. If any error is triggered within the video game, it may be displayed immediately on the monitor, including a full error trace and session log associated with it. For critical errors, the one or more processors may send an email, for example, to the technical leads of the test project. Quick access to error logs enables test and/or development engineers to identify problems immediately. The real-time monitoring and error reporting may allow engineers to fix minor issues without delay, and more complex issues can be reported to the QA analysts for further study and solution design.

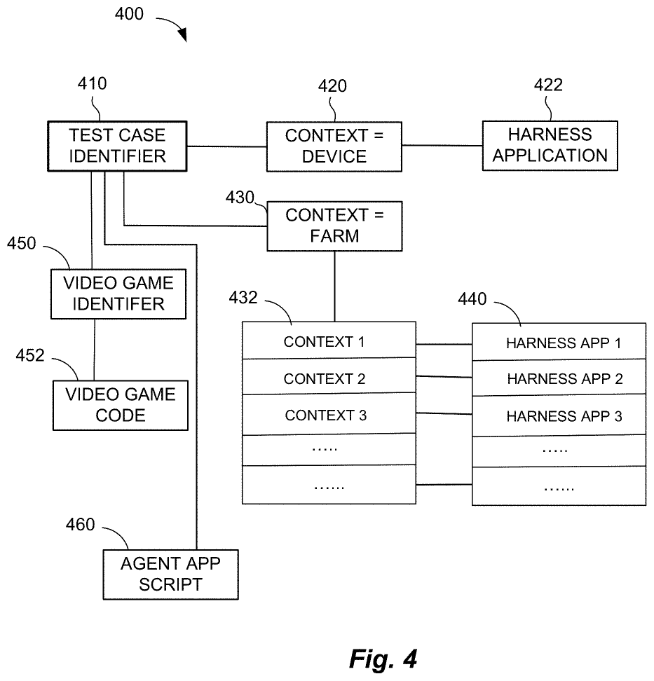

FIG. 4 shows aspects of a test case data structure 400 in a computer memory for use by one or more processors in automatically evaluating performance of a video game by a computing device. In an aspect, each test case data structure may be referenced by a test case identifier 410. Each test case identifier 410 may be, for example a code or an address. Based on the test case identifier 410, the one or more processors may look up further instructions and/or data in pre-defined data structures. A test case may generally specify the execution context, or the test device's testing environment. More specifically, an execution context 420 may identify the test device as a single mobile device, or an execution context 430 may identify a test farm. A device farm may include devices having different models and operating systems; thus each device has its own execution context stored in context table 432.

In an aspect, each execution context structure links to a corresponding harness application. Knowing the execution context for a test case, the one or more processors can look up and load the corresponding harness application. For example, a single-device execution context entry 420 links to a harness application 422. Similarly, each execution context of a device farm structure 432 links to a corresponding harness application in a harness application table 440. In an aspect, the test case identifier 410 may link to a game identifier 450 which may link at least to a video game code 452. In an aspect, the test case identifier 410 may also link to an agent application script 460. As described herein, one or more processors may build the game code and agent application script in one package before loading into a mobile device for testing. In an aspect, the video game identifier can be null when the video game is pre-loaded in the device.

In an aspect, the agent application may be a Finite State Machine (FSM) automata whose purpose is to imitate a player. A QA analyst or engineer may configure the agent application directly according to the test to perform. The agent application differs from the traditional automated QA process, where simple UI Automation scripts are limited to simulating mouse clicks or button taps. With the agent application, the analyst can reason in terms of in-game actions a real-life player would perform. In an aspect, the agent application may include game-play functions, debug functions, performance profiling functions and generic functions. The following lists examples of functions of an agent application. In practice, game functions will vary depending on the game and version.

Game-Specific Gameplay Functions:
1. GoToCampaignMap( )
2. GoToSuperTeamScreen( )
3. BuildRandomSuperteam( )
4. GoToBattle( )
5. WaitForBattleToLoad( )
6. WaitForBeamIn(float timeoutSecs)
7. SetBattleAutoMode(bool autoOn)
8. WaitForBattleToEnd( )
9. ReplayBattle( )
10. GoHome( )
11. GoToHeroesScreen( )
12. GoToHeroProfile( )
13. GoToStore( )
14. PurchaseEnergy( )
15. GoToRandomStoreTab( )
16. GoToMissionsScreen( )
17. GoToHeroProfileForId(string characterld)
18. GoToUpgradeEvents( )
19. GoToLiveChallenge(string cardName)
20. GoToPvP( )
21. GoToChat( )
22. SendChatMessage(string message)
23. BuildSuperteamForIDs(string[ ] characterProtoIDs, int superTeam=0)

Game-Specific Debug Functions:
24. DebugUnlockCharacters( )
25. DebugMaxOutCharacters( )
26. WaitForWatchtowerLoad( )
27. DebugGrantCurrency( )
28. DebugGrantShards( )
29. DebugGiveMaterials( )
30. DebugGiveXPItems( )
31. DebugLevelUpSkills( )
32. DebugKillWave( )

Performance Profiling Functions:
33. ProfileCharacter( )
34. ProfileEnvironment(HashSet<string>layers)
35. GoToChoreographyTool( )
36. LoadScene(string sceneID, string encounterName)
37. LoadCharacter(string characterProtoID, bool legendary)
38. ProfileMove(int movelndex)
39. ProfileHardware( )
40. GoToHeroChallenges( )
41. ForceSmokeState(string state)

Generic Functions:
42. WaitForSeconds(float seconds)
43. TriggerObjectAtPath(string path, string triggerMessage, string nextState)
44. TriggerButtonAtPath(string path, string nextState)
45. TriggerButtonAtPath(string path)
46. TriggerObject(string objectType, string objectName, int index, string triggerMessage, string nextState)
47. TriggerButton(string buttonName, string nextState, int index=0)
48. TriggerButton(string buttonName, int index=0)
49. SaveScreenshot( )

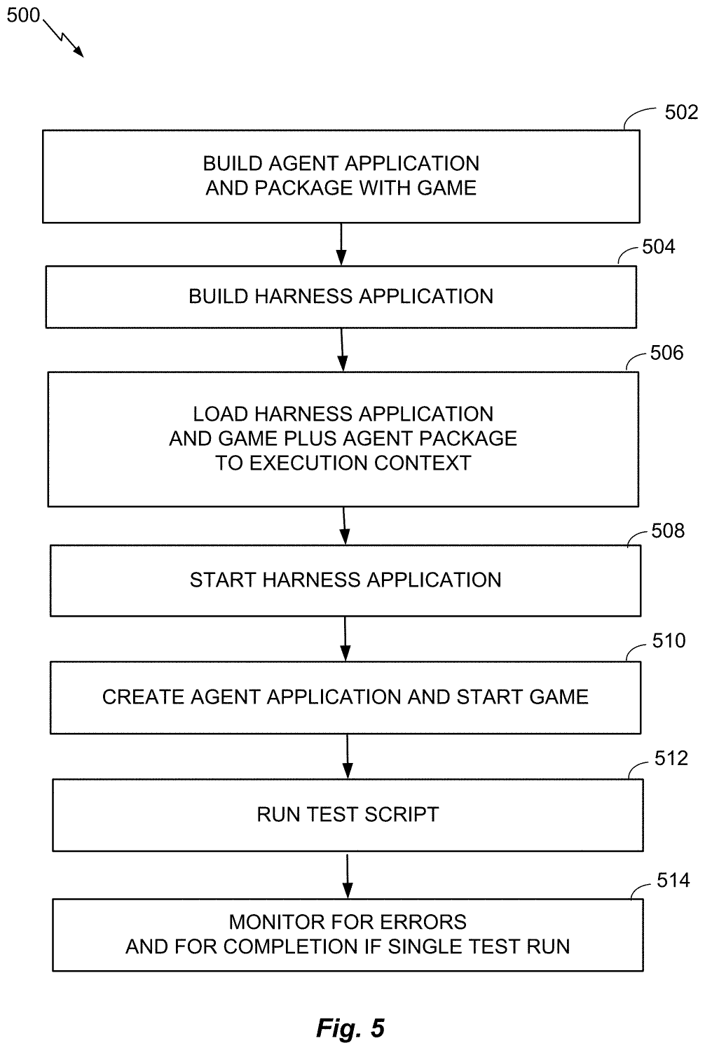

FIG. 5 diagrams a high-level process 500 of building and executing an automatic evaluation performance of a video game by a computing device. At 502, one or more processors build an agent application script for testing a video and package the script together with the video game, based on input from a user. e.g., a QA analyst (or the like). At 504, the one or more processors look up the execution context and build the harness application, again with user input as needed. At 506, the one or more processors load the harness application and the package of agent application and game to the device, which may be a device farm, a continuous integration server, a local test server or station, or a local computer.

At 508, one or more processors at the device execution context start the execution of the harness application. In an aspect, at 510, the harness application extracts and gathers variable values, for example configuration variables, from the mobile device, creates the agent application and starts the game. In another aspect, the harness application may direct the game to create the agent application. At 512, the game may run the script which configures the agent application. In an aspect, the game passes the script as a code “handle” to the agent. In an aspect, the game may create a test strategy, for example as specified in the script. The agent application executes its code instructions, gathers statistics and screenshots if so directed. In an aspect, the one or more processors may contemporaneously send the statistics and screenshots to a display. At 514, the harness application monitors for errors and for signal of test completion if test is a single test run. In an aspect, when the test completes the one or more processors at the device execution context collects test results, performs clean-up functions and terminates execution of the harness application.

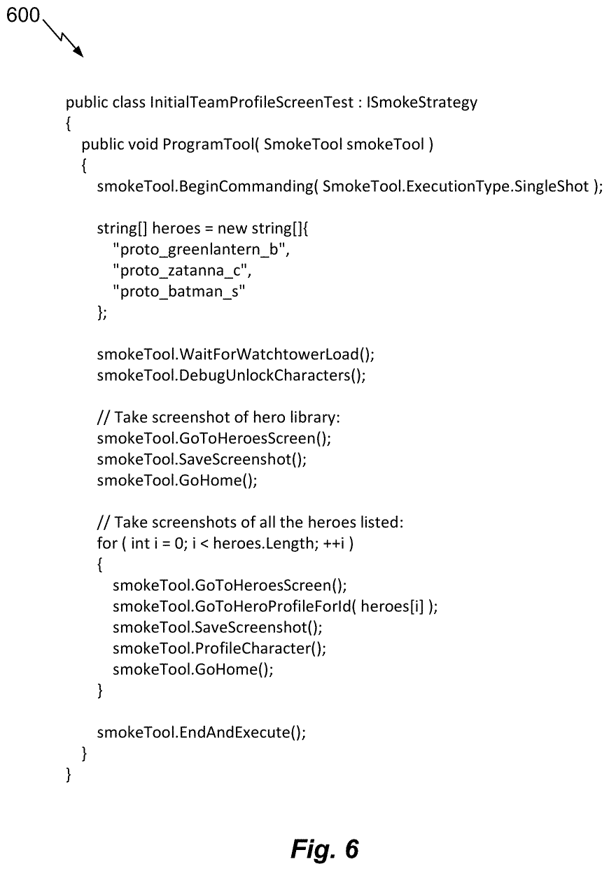

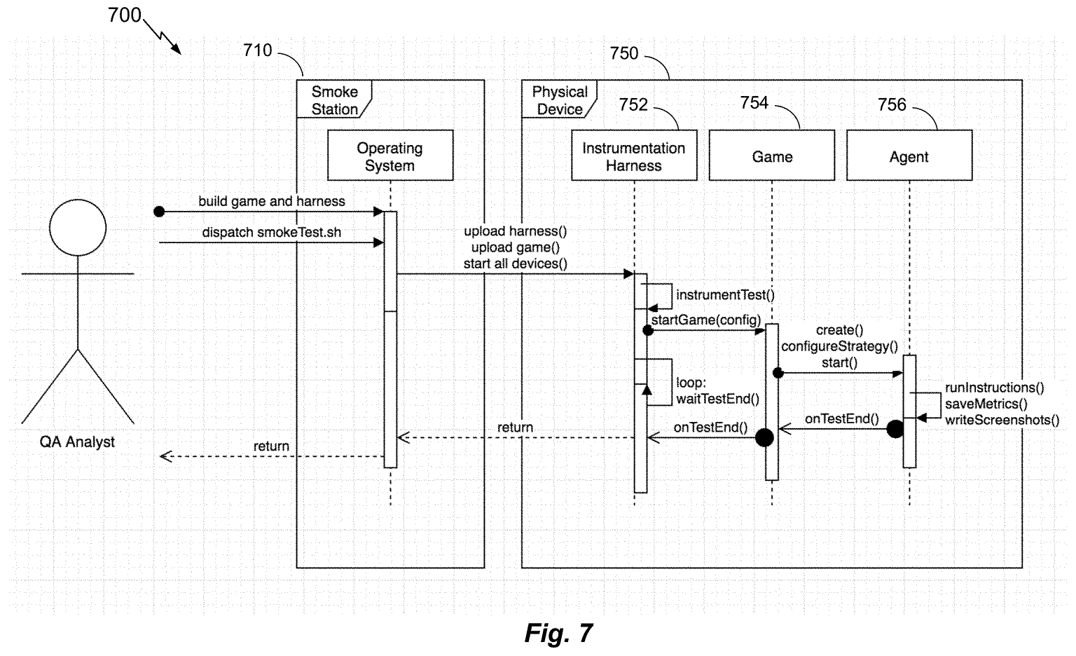

FIG. 6 illustrates an exemplary program script 600 of an automatic evaluation performance of a video game by a computing device. The script 600 runs a simple test that takes a screenshot of 3 in-game characters. The script leverages both generic and game-specific functions (shown above) of an agent application to build the test. The script is completely isolated from the execution context so that the test can be “portable” between different execution contexts via a harness application. In the code sample 600, “smokeTool” is a handle to the instance of an agent application that will be created by the Game Initialization State at the request of the harness application (see associated Sequence Diagrams in FIG. 7). In an aspect, when the ExecutionMode is SingleShot (single test run as shown), it will signal to the harness application that the test is complete when all instructions have executed. Otherwise, if the ExecutionMode is Continuous, the agent application will restart from the first instruction.

FIG. 7 is a block diagram 700 showing execution flow of script 600 in FIG. 6 in a single device. In an aspect, a QA analyst builds the harness application (shown as Instrumentation Harness) 752 in the local server 710 (shown as Smoke Station). The harness application 752, game 754 and agent application 756 are loaded into device 750 (e.g., a mobile device) for testing the game. In an aspect, a local server 710 that may continuously run tests on the video game. To this end, the agent application 756 can be furnished with a “continuous execution” mode, which allows running a test not only once, but also to loop indefinitely, trying all possible game state combinations over time.

In an aspect, a server 710 may be constructed for each platform of interest, to enable concurrent testing of different platforms and to optimize the sever 710 for use with particular platforms. For example, it may be advantageous to build separate servers, one for testing iOS versions of games and one for Android versions.

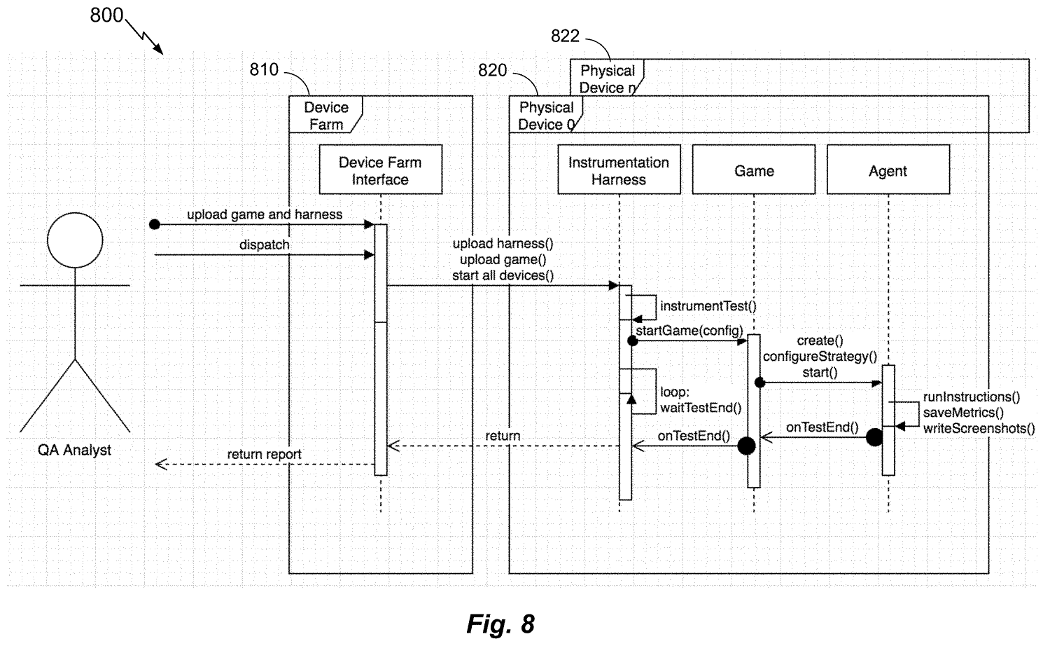

FIG. 8 is a block diagram 800 showing execution flow of script 600 in FIG. 6 in a device farm. In an aspect, a QA analyst builds and loads the harness application (shown as Instrumentation Harness) to the device farm 810. The harness application, game and agent application are loaded into each of the multiple devices 820, 822, etc. (e.g., mobile devices) for testing the game in each device. Except for the multiple device setup, the testing of each device is similar to that of FIG. 7.

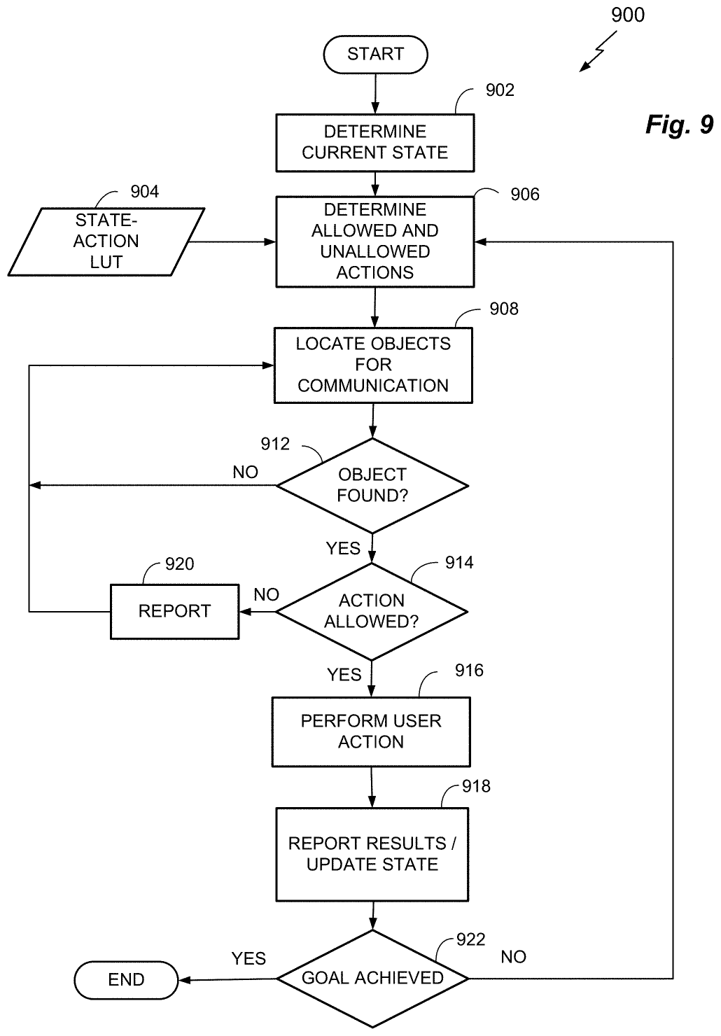

FIG. 9 diagrams a useful automatic process 900 of an agent application built into a video game for automatically evaluating performance of the video game by a computing device. At 902, a processor determines the current state of the agent application FSM. At 906, the processor determines, for example by looking up a look-up table 904, data indicating player actions that are allowed and not allowed for the current state which also represents the state of the game. At 908, in an aspect, the processor locates objects of interest in the device's memory to trigger actions on the located objects. In an aspect, the data may be segregated by player cohorts. For example, a data set may focus on the top 10% players of the game (90th percentile) and exclude other player data, or any other desired player group. The actions of this cohort can be observed and analyzed to determine relevant use parameters, for example, frequency of use and context of use. The actions can then be coded directly into high-level agent application instructions to perform according to the relevant usage parameters. Focusing on a cohort (e.g., top 10%) may enable the developer to find the most common issues for the most active players, enabling the developers to prioritize fixes to these areas of the video game.

At 912, the processor determines whether an object of interest has been found. If not, in an aspect, the processor returns to 908 to look for another object. In an aspect, the processor may also report ‘object not found’ (not shown). At 914, if an object of interest has been found, the processor determines whether a player action is allowed for the object in the current state of the game. In an aspect, if no action is allowed, the processor reports the condition at 920, then return to 908 to look for another object. If an action is allowed, the processor proceeds to 916 and performs the allowed action. At 918, the processor reports the result(s) of the action, stores any associated data, and updates the game (and agent application) state.

At 922, the processor determines whether the objective(s) for the test has(have) been achieved. If so, the processor reports the results and ends the test.

In an aspect, the on-device agent application can support capabilities that allow leveraging social features of a video game in order to simulate interactions between different players. This is especially valuable for the automated testing of video games with synchronous Player vs Player (PvP) interactions, resource trading and any other player-to-player interactions. Interactions like these, in a massive scale, are generally very cumbersome or outright impossible for a team of QA Analysts to test manually.

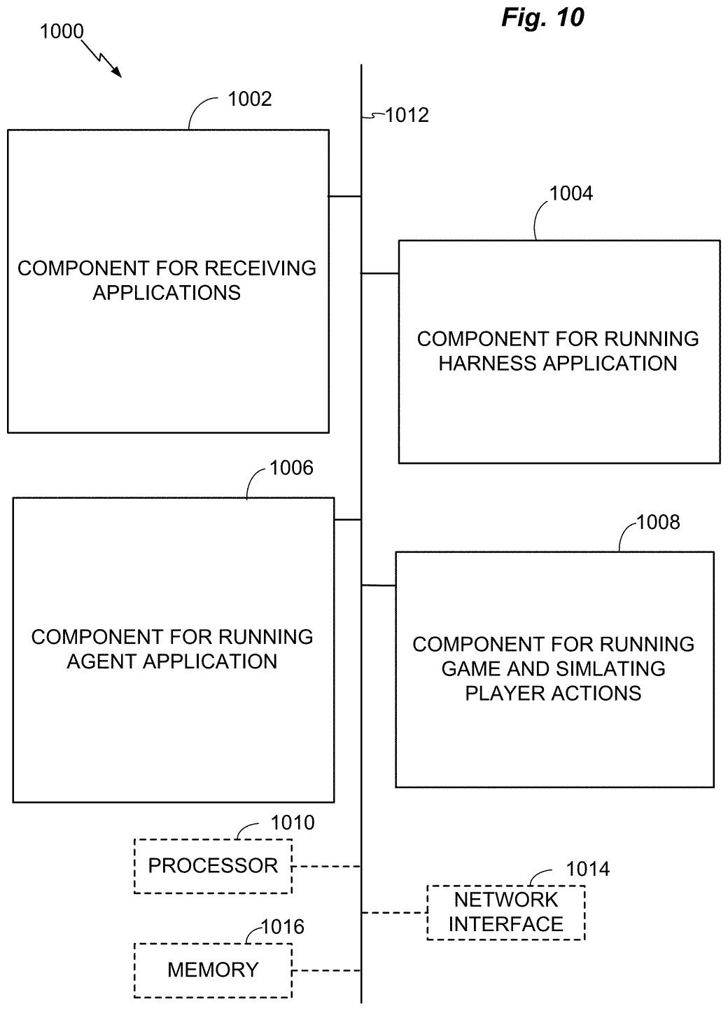

FIG. 10 is a conceptual block diagram illustrating components of a computing device 1000 for automatically evaluating performance of the video game by the computing device as described herein, according to one embodiment. As depicted, the apparatus or system 1000 may include functional blocks that can represent functions implemented by a processor, software, or combination thereof (e.g., firmware).

As illustrated in FIG. 10, the computing device 1000 may comprise an electrical component 1002 for receiving application codes. The applications may include a harness application, and a package of agent application and the video game. The component 1002 may be, or may include, a means for said receiving. Said means may include the processor 1010 coupled to the memory 1016, and to the network interface 1014, the processor executing an algorithm based on program instructions stored in the memory. Such algorithm may include a sequence of more detailed operations, for example, serving a user interface for a terminal, the user interface including on or more menus for selecting high-level game events and arranging in a list or sequence, receiving selections and edits from a user via the user interface, and arranging a list of high-level instructions in response to the selections and edits. See also FIG. 5 at 502

The computing device 1000 may further comprise an electrical component 1004 for executing a harness application. The component 1004 may be, or may include, a means for said executing. Said means may include the processor 1010 coupled to the memory 1016, and to the network interface 1014, the processor executing an algorithm based on program instructions stored in the memory. Such algorithm may include a sequence of more detailed operations, for example, as described in connection with, for example, as described in connection with processes 102-104 and 504-508 of FIGS. 1 and 5 above, and with block 752 of FIG. 7. The sequence of detailed operations may further include bootstrapping an agent application on each device under test, the agent configured with a sequence of high-level instructions from the receiving component 1002.

The computing device 1000 may further comprise an electrical component 1006 for executing an agent application. The component 1006 may be, or may include, a means for said converting. Said means may include the processor 1010 coupled to the memory 1016, and to the network interface 1014, the processor executing an algorithm based on program instructions stored in the memory. Such algorithm may include a sequence of more detailed operations, for example, as described in connection with processes 108-110, 510-514 and method 900 of FIGS. 1, 5 and 9 and block 756 of FIG. 7. The more detailed instructions may include, for example, running an executable loop of high-level videogame instructions and testing the game's reaction to the instructions against a standard.

The computing device 1000 may further comprise electrical components 1008 for executing a video game. The component 1008 may be, or may include, a means for said executing. Said means may include the processor 1010 coupled to the memory 1016, and to the network interface 1014, the processor executing an algorithm based on program instructions stored in the memory. Such algorithm may include a sequence of more detailed operations, for example, as described in connection with processes 106 and 510 of FIGS. 1 and 5 above, and with block 754 of FIG. 7. The video game runs in its native state as it would with a user, reacting to inputs from the agent application.

As shown, the computing device 1000 may include a processor component 1010 having one or more processors, which may include a digital signal processor. The processor 1010, in such case, may be in operative communication with the modules 1002-1008 via a bus 1012 or other communication coupling, for example, a network. The processor 1010 may initiate and schedule the functions performed by electrical components 1002-1008.

In related aspects, the computing device 1000 may include a network interface module 1014 operable for communicating with a storage device, with servers, or other remote devices over a computer network. In further related aspects, the computing device 1000 may optionally include a module for storing information, such as, for example, a memory device/module 1016. The computer readable medium or the memory module 616 may be operatively coupled to the other components of the computing device 1000 via the bus 1012 or the like. The memory module 1016 may be adapted to store computer readable instructions and data for effecting the processes and behavior of the modules 1002-1008, and subcomponents thereof, or the processor 1010, or the methods described herein. The memory module 1016 may retain instructions for executing functions associated with the modules 1002-1008. While shown as being external to the memory 1016, it is to be understood that the modules 1002-1008 can exist within the memory 1016.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer or system of cooperating computers. By way of illustration, both an application running on a server and the server can be a component. One or more components may reside within a process and/or thread of execution and a component may be localized on one computer and/or distributed between two or more computers.

In the foregoing description and in the figures, like elements are identified with like reference numerals. The use of “e.g.,” “etc.,” and “or” indicates non-exclusive alternatives without limitation, unless otherwise noted. The use of “including” or “include” means “including, but not limited to,” or “include, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

In many instances, entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise. The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Various aspects will be presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects.

The previous description of the disclosed aspects is provided to enable any person skilled in the art to make or use the present disclosure. Various modifications to these aspects will be clear to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

1. A method for evaluating performance of a video game by a computing device, the method comprising:
executing by a processor of the computing device a harness application for the video game that extracts variable values from a memory of the computing device and sends data based on the values to a data sink;
contemporaneously with executing the harness application, executing by a processor of the computing device an agent application for the video game that executes player commands for the video game based on a script and state of the computing device determined by the video game;
contemporaneously with executing the harness application and the agent application, executing by a processor of the computing device the video game that accepts input generated by the agent application as player input; and
storing the data in the data sink for analysis.

2. The method of claim 1, further comprising continuing the executing the harness application, the agent application, and the video game until achieving a predefined objective of video game play.

3. The method of claim 1, further comprising continuing the executing the harness application, the agent application, and the video game indefinitely.

4. The method of claim 1, wherein executing the agent application causes the computing device to read a data file that defines one or more game objectives.

5. The method of claim 4, wherein executing the agent application causes the computing device to generate simulated user input based on the one or more game objectives.

6. The method of claim 5, wherein executing the agent application causes the computing device to generate the simulated user input at least in part by reacting to a detected state of the video game according to at least one predefined algorithm.

7. The method of claim 1, further comprising coupling the computing device to the data sink by at least one of a serial port or a network interface.

8. The method of claim 1, further comprising hosting the data sink by a local server.

9. The method of claim 1, further comprising hosting the data sink by a server and executing on the server a data management application that causes the server to receive the data from the computing device and record the data in a computer-readable storage medium.

10. The method of claim 9, wherein the data management application further causes the server to receive additional data similar to the data from multiple different computing devices contemporaneously performing the method.

11. The method of claim 1, wherein executing the harness application causes the computing device to collect at least one of: one or more screenshots, a current framerate, a measure of CPU usage, a measure of graphics processor usage, a measure of memory usage, a measure of power drain, or a measure of screen brightness.

12. (canceled)

13. (canceled)

14. An apparatus for evaluating performance of a video game by a computing device, the apparatus comprising at least one processor coupled to a memory holding program instructions that when executed by the at least one processor cause the apparatus to perform:
executing a harness application for the video game that extracts variable values from a memory of the computing device and sends data based on the values to a data sink;
contemporaneously with executing the harness application, executing an agent application for the video game that executes player commands for the video game based on a script and state of the computing device determined by the video game;
contemporaneously with executing the harness application and the agent application, executing the video game that accepts input generated by the agent application as player input; and
storing the data in the data sink for analysis.

15. The apparatus of claim 14, wherein the memory holds further instructions for continuing the executing the harness application, the agent application, and the video game until achieving a predefined objective of video game play.

16. The apparatus of claim 14, wherein the memory holds further instructions for continuing the executing the harness application, the agent application, and the video game indefinitely.

17. The apparatus of claim 14, wherein the memory holds further instructions for executing the agent application thereby causing the computing device to read a data file that defines one or more game objectives.

18. The apparatus of claim 17, wherein the memory holds further instructions for executing the agent application thereby causing the computing device to generate simulated user input based on the one or more game objectives.

19. The apparatus of claim 18, wherein the memory holds further instructions for executing the agent application thereby causing the computing device to generate the simulated user input at least in part by reacting to a detected state of the video game according to at least one predefined algorithm.

20. (canceled)

21. (canceled)

22. The apparatus of claim 14, wherein further comprising a server configured for executing a data management application that causes the server to receive the data from the computing device and record the data in a computer-readable storage medium and to receive additional data similar to the data from multiple different computing devices contemporaneously.

23. (canceled)

24. (canceled)

25. The apparatus of claim 14, wherein the agent application is a finite state machine.

26. The apparatus of claim 14, wherein the agent application is encoded as a part of the video game application.

27. (canceled)
